(19) United States
(12) Patent Application Publication
(10) Pub. No.: US 2008/0133895 A1
(43) Pub. Date: Jun. 5, 2008

(54) Floating Point Addition

(76) Inventors: Alexey Yurievich Sivtsov, Moscow (RU); Valery Yakovlevich Gorshtein, Moscow (RU)

Correspondence Address: CAVEN & AGHEVLI;c/o INTELLEVATE, P.O. BOX 52050, MINNEAPOLIS, MN, 55402, US

(21) Appl. No.: 10/589,448

(22) PCT Filed: May 16, 2006
(86) PCT No.: PCT/RU06/00236

§ 371 Date: Aug. 11, 2006

(51) Int. Cl. G06F 9/302

(52) U.S. Cl. 712/222; 712/E09.017

(57) ABSTRACT

Methods and apparatus to perform floating point addition are described. In one embodiment, a plurality of operands are formatted into a common format and combined (e.g., added or subtracted). Other embodiments are also described.

### BACKGROUND

The present disclosure generally relates to the field of electronics. More particularly, an embodiment of the invention relates to techniques to perform floating point addition within a computer system.

Floating point representations of numbers may be used to provide efficiency when performing arithmetic operations on real numbers. Depending on precision requirements, differing floating point representation formats may be utilized. For example, real numbers may be represented as a single precision floating point number, a double precision floating point number, or a double-extended precision floating number. To increase computational efficiency, some processors or computer systems may include more than one floating point adder to operate on numbers having different floating point formats. Having different floating point adders for different floating point formats may cause more die area on a processor to be consumed, as well as additional power.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIGS. 1, 8, and 9 illustrate block diagrams of embodiments of computing systems, which may be utilized to implement various embodiments discussed herein.

FIG. 2 illustrates a block diagram of portions of a processor core, according to an embodiment of the invention.

FIGS. 3 and 4 illustrate block diagrams of portions of a floating point adder, according to various embodiments of the invention.

FIGS. 5 and 6 illustrate operand formats in accordance with various embodiments of the invention.

FIG. 7 illustrates a flow diagram of an embodiment of a method in accordance with an embodiment of the invention.

### DETAILED DESCRIPTION

In the following description, numerous specific details are set forth in order to provide a thorough understanding of various embodiments. However, some embodiments may be practiced without the specific details. In other instances, well-known methods, procedures, components, and circuits have not been described in detail so as not to obscure the particular embodiments. Various aspects of embodiments of the invention may be performed using various means, such as integrated semiconductor circuits (“hardware”), computer-readable instructions organized into one or more programs (“software”) or some combination of hardware and software. For the purposes of this disclosure reference to “logic” shall mean either hardware, software, or some combination thereof.

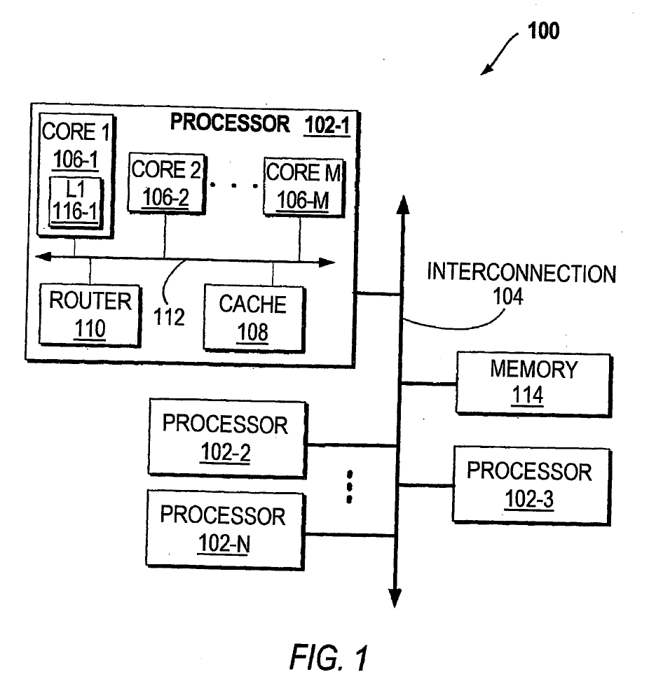

Some of the embodiments discussed herein may provide efficient mechanisms for adding floating point numbers. In one embodiment, the same logic may be used for addition and/or subtraction. For example, addition of floating point numbers with opposite signs may correspond to a subtraction operation. Further, in an embodiment, the same floating point adder logic may be used for addition (and/or subtraction) of floating point numbers that are represented in varying floating point representation formats, for example, as a single precision, a double precision, and/or a double-extended precision floating number. Additionally, such a floating point adder may be utilized in a processor core, such as the processor cores discussed with reference to FIGS. 1-9. More particularly, FIG. 1 illustrates a block diagram of a computing system 100, according to an embodiment of the invention. The system 100 may include one or more processors 102-1 through 102-N (generally referred to herein as “processors 102” or “processor 102”). The processors 102 may communicate via an interconnection or bus 104. Each processor may include various components some of which are only discussed with reference to processor 102-1 for clarity. Accordingly, each of the remaining processors 102-2 through 102-N may include the same or similar components discussed with reference to the processor 102-1.

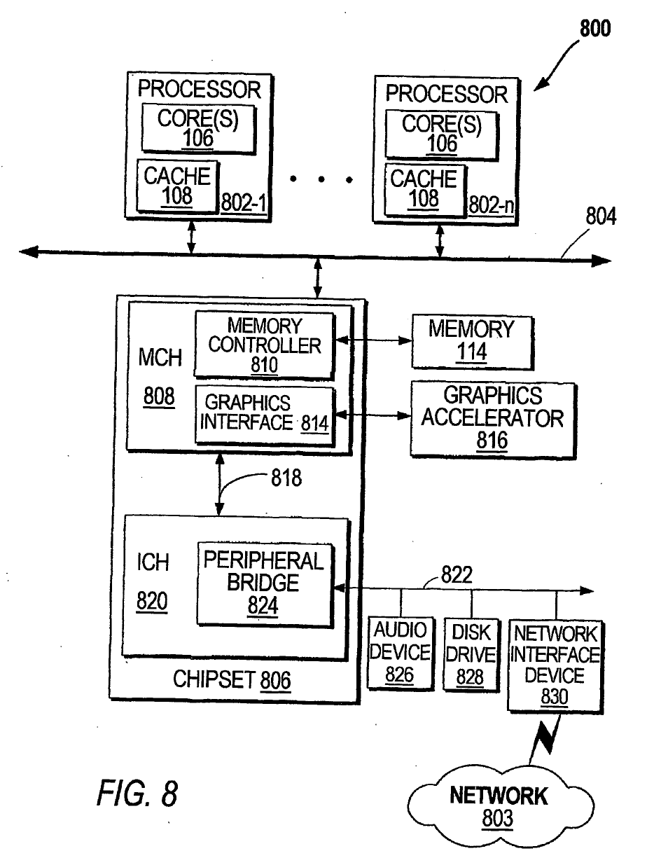

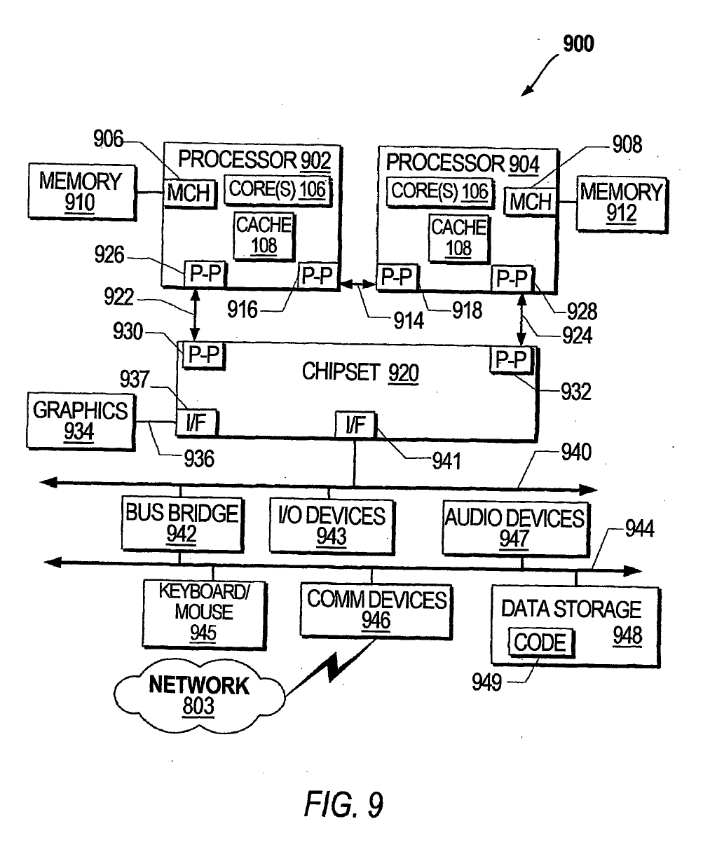

In an embodiment, the processor 102-1 may include one or more processor cores 106-1 through 106-M (referred to herein as “cores 106,” or more generally as “core 106”), a cache 108 (which may be a shared cache or a private cache in various embodiments), and/or a router 110. The processor cores 106 may be implemented on a single integrated circuit (IC) chip. Moreover, the chip may include one or more shared and/or private caches (such as cache 108), buses or interconnections (such as a bus or interconnection 112), memory controllers (such as those discussed with reference to FIGS. 8 and 9), or other components.

In one embodiment, the router 110 may be used to communicate between various components of the processor 102-1 and/or system 100. Moreover, the processor 102-1 may include more than one router 110. Furthermore, the multitude of routers (110) may be in communication to enable data routing between various components inside or outside of the processor 102-1.

The cache 108 may store data (e.g., including instructions) that are utilized by one or more components of the processor 102-1, such as the cores 106. For example, the cache 108 may locally cache data stored in a memory 114 for faster access by the components of the processor 102. As shown in FIG. 1, the memory 114 may be in communication with the processors 102 via the interconnection 104. In an embodiment, the cache 108 (that may be shared) may include a mid-level cache and/or a last level cache (LLC). Also, each of the cores 106 may include a level 1 (L1) cache (116-1) (generally referred to herein as “L1 cache 116”). Various components of the processor 102-1 may communicate with the cache 108 directly, through a bus (e.g., the bus 112), and/or a memory controller or hub.

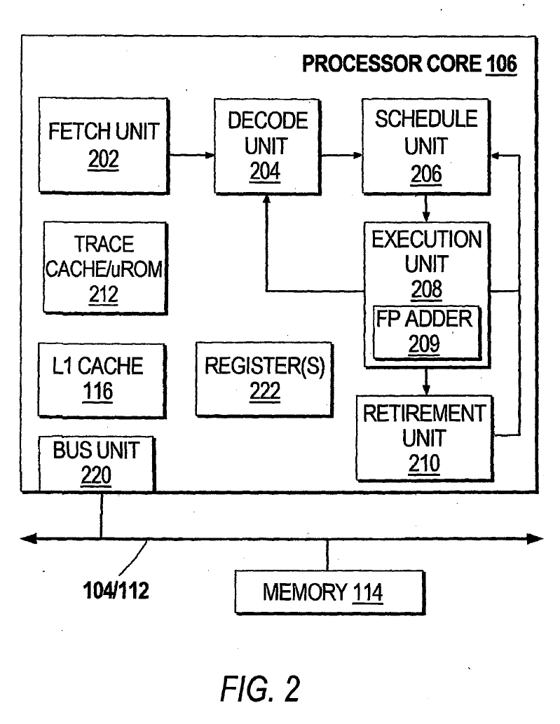

FIG. 2 illustrates a block diagram of portions of a processor core 106, according to an embodiment of the invention. In one embodiment, the arrows shown in FIG. 2 illustrate the flow direction of instructions through the core 106. One or more processor cores (such as the processor core 106) may be implemented on a single integrated circuit chip (or die) such as discussed with reference to FIG. 1. Moreover, the chip may include one or more shared and/or private caches (e.g., cache 108 of FIG. 1), interconnections (e.g., interconnections 104 and/or 112 of FIG. 1), memory controllers, or other components.

As illustrated in FIG. 2, the processor core 106 may include a fetch unit 202 to fetch instructions for execution by the core 106. The instructions may be fetched from any storage devices such as the memory 114 and/or the memory devices discussed with reference to FIGS. 8 and 9. The core 106 may also include a decode unit 204 to decode the fetched instruction. For instance, the decode unit 204 may decode the fetched instruction into a plurality of uops (micro-operations). Additionally, the core 106 may include a schedule unit 206. The schedule unit 206 may perform various operations associated with storing decoded instructions (e.g., received from the decode unit 204) until the instructions are ready for dispatch, e.g., until all source values of a decoded instruction become available. In one embodiment, the schedule unit 206 may schedule and/or issue (or dispatch) decoded instructions to an execution unit 208 for execution. The execution unit 208 may execute the dispatched instructions after they are decoded (e.g., by the decode unit 204) and dispatched (e.g., by the schedule unit 206). In an embodiment, the execution unit 208 may include more than one execution unit, such as a memory execution unit, an integer execution unit, a floating-point execution unit, or other execution units. The execution unit 208 may also perform various arithmetic operations such as addition, subtraction, multiplication, and/or division, and may include one or more an arithmetic logic units (ALUs). In an embodiment, a co-processor (not shown) may perform various arithmetic operations in conjunction with the execution unit 208.

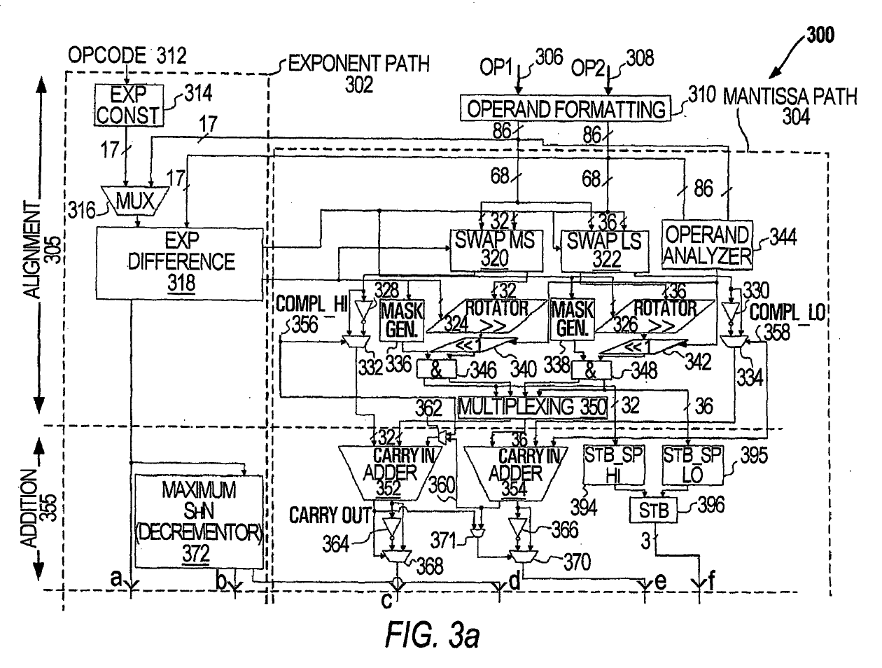

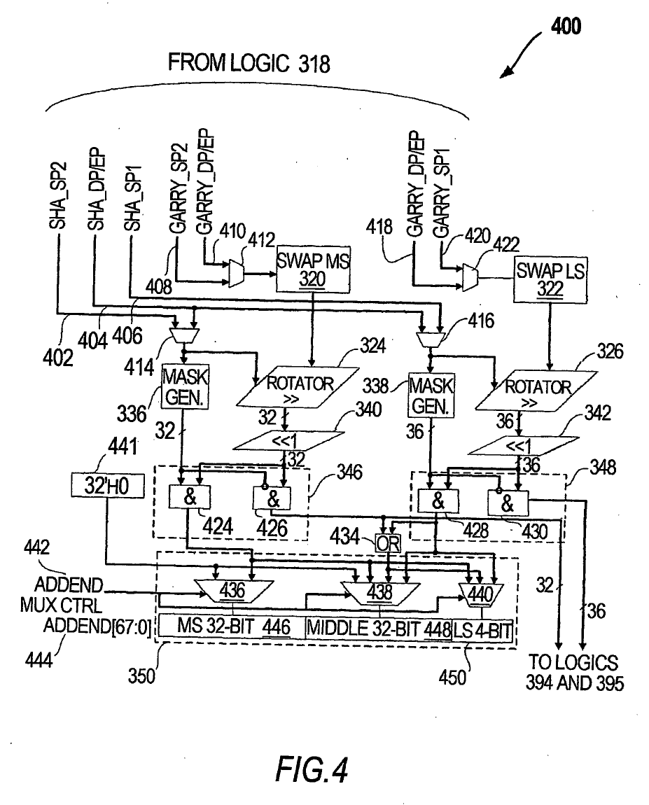

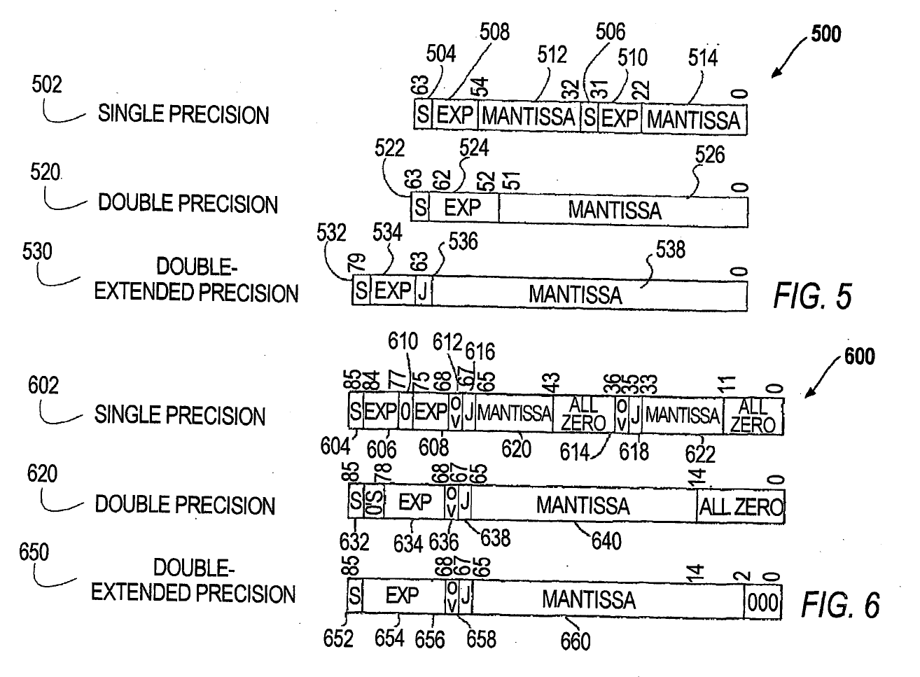

As shown in FIG. 2, the execution unit 208 may include a floating point (FP) adder 209 to perform addition, subtraction, comparison, and/or format conversion of floating numbers that may be represented in varying floating point representation formats. In one embodiment, the floating point numbers being added and/or subtracted may have any format, e.g., including a single precision, a double precision, and/or a double-extended precision floating number format (such as those discussed with reference to FIGS. 5 and 6). In an embodiment, the adder 209 may operate in response to a single instruction, multiple data (SIMD) instruction. Generally, an SIMD instruction may cause identical operations to be performed on multiple pieces of data at the same time, e.g., in parallel. Moreover, in accordance with at least one instruction set architecture, the SIMD instruction may correspond to streaming SIMD extensions (SSE) or other forms of streaming SIMD implementations (such as streaming SIMD extensions 2 (SSE2)). Further details regarding, various embodiments of the adder 209 will be further discussed herein, e.g., with reference to FIGS. 3-7. Also, the execution unit 208 may include more than one floating point adder 209. Further, the execution unit 208 may execute instructions out-of-order. Hence, the processor core 106 may be an out-of-order processor core in one embodiment. The core 106 may also include a retirement unit 210. The retirement unit 210 may retire executed instructions after they are committed. In an embodiment, retirement of the executed instructions may result in processor state being committed from the execution of the instructions, physical registers used by the instructions being de-allocated, etc.

The core 106 may additionally include a trace cache or microcode read-only memory (uROM) 212 to store microcode and/or traces of instructions that have been fetched (e.g., by the fetch unit 202). The microcode stored in the uROM 212 may be used to configure various hardware components of the core 106. In an embodiment, the microcode stored in the uROM 212 may be loaded from another component in communication with the processor core 106, such as a computer-readable medium or other storage device discussed with reference to FIGS. 8 and 9. The core 106 may also include a bus unit 220 to enable communication between components of the processor core 106 and other components (such as the components discussed with reference to FIG. 1) via one or more buses (e.g., buses 104 and/or 112). The core 106 may also include one or more registers 222 to store data accessed by various components of the core 106.

FIG. 3 illustrates a block diagram of portions of a floating point adder (209), according to an embodiment of the invention. The floating point adder 209 of FIG. 3 may be the same or similar to the floating point adder 209 discussed with reference to FIG. 2. The width of various signal paths of the adder 209 are shown in FIG. 3 in example, to provide mantissa alignment, such as discussed and illustrated with reference to FIG. 3.

The mantissa path 304 may include logics 320 and 322 to receive the formatted operands from the logic 310 and swap (or extract a portion of) the mantissas, e.g., based on carry-out signals generated from the exponent difference computation by the logic 318. Alignment of the mantissas corresponding to the operand with smaller exponent is performed using rotators (e.g., logics 324 and 326) and mask generators (e.g., mask generators 336 and 338). In an embodiment, one or more of the signals generated by the logic 318 may be used for determining shift code alignment, e.g., to enable the mantissas corresponding to the operand with smaller exponent to be cycle shifted right by rotators 324 and 326. Also, in one embodiment, the shift code signals provided by the logic 318 to logics 324 and 326 may be five bits wide. For double precision and double-extended precision operands, the shift code (and/or carryout) signals provided to logics 324 and 326 may be the same in an embodiment. Moreover, the logics 320 and 322 may provide the mantissas of operands 306 and 308 with larger exponents to inverters 328 and 330 and multiplexers 332 and 334. Moreover, mask generators 336 and 338 may generate masks based on shift code signals from the logic 318 to enable the shifting of one or more bits of the outputs of logics 324 and 326.

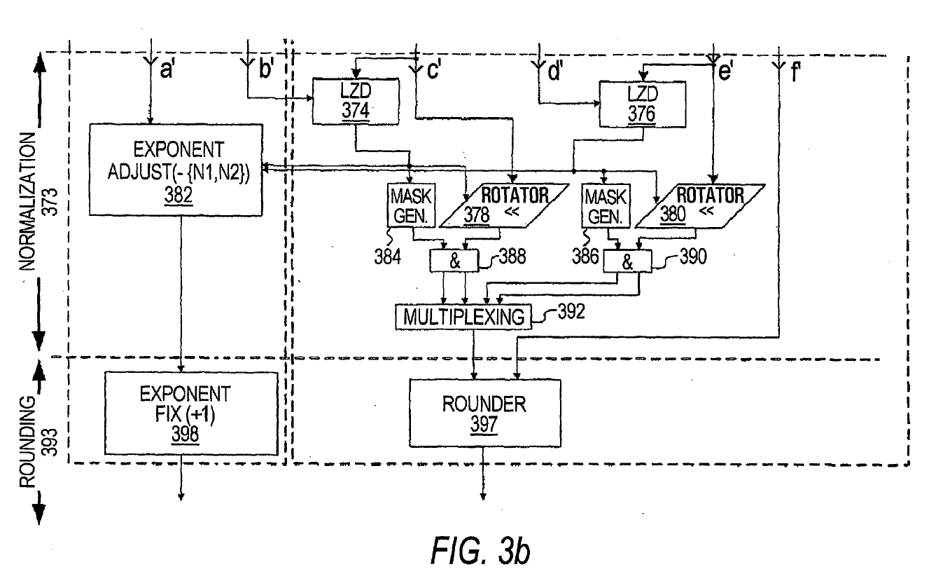

As shown in FIG. 3, the outputs of logics 324 and 326 may be shifted left by one bit by logics 340 and 342, respectively. In particular, an operand analyzer 344 may analyze the operands 306 and 308, and generate one or more signals to enable shifting in logics 340 and 342 if one of the operands is denormal. Logic 346 logically combines (e.g., by using an AND operation) the outputs of the mask generator 336 and logic 340. Similarly, logic 348 logically combines (e.g., by using an AND operation) the outputs of the mask generator 338 and logic 342. A multiplexing logic 350 receives the outputs of the logics 346 and 348 and provides a signal to one of the inputs of each of the adders 352 and 354 which are in an addition portion 355 of the adder 209. Additional details regarding an embodiment of the logics 346, 348, and 350 are further discussed with reference to FIG. 4.

As illustrated in FIG. 3, the adders 352 and 354 may also receive an input signal form the multiplexers 332 and 334. The multiplexers 332 and 334 may select one of their inputs based on signals 356 (Compl_Hi) and 358 (Compl_Lo) which may be generated based on opcode (312) and signs of operands (e.g., operands 306 and 308) to provide a (true) subtraction (e.g., subtraction of operands with the same signs or the addition of operands with different signs) or a (true) addition operation (e.g., subtraction of operands with different signs or the addition of operands with the same signs) by an opcode decoder logic (not shown). Accordingly, the adders 352 and 354 may receive aligned and non-aligned mantissas, e.g., through multiplexers 332 and 334 which may in turn provide the non-inverted or inverted (for example by inventors 328 and 330) mantissas selected by logics 320 and 322, respectively. The adders 352 and 354 also receive carry in signals. For example, adder 354 receives as carry in signals the signal 358, e.g., to provide full two's complementing for true subtraction cases. The adder 352 receives as its carry in signal a carry out signal 360 from the adder 354 or the signal 356 that may be provided through a multiplexer 362 based on the precision format of the opcode 312. The outputs of the adders 352 and 354 are provided to inverters 364 and 366, and multiplexers 368 and 370. The multiplexers 368 and 370 may select one of their input signals as output based on a selection signal generated by the adder 352 and a multiplexer 371, respectively. In an embodiment, since mantissa of operand with larger or equal exponent may be two's complemented for the true subtraction cases, the result of addition may be negative and can be two's complemented. The two's complementing may be performed by inversion of results of adders 352 and 354 and adding of a binary one (“1”) using a rounder hardware (e.g., logic 397). The exponent path 302 of the addition portion 355 may also include a logic 372 to generate a limiter shift value for normalization, e.g., because the adder 209 may support gradual underflow.

The outputs of multiplexers 368 and 370 and the logic 372 is provided to a normalization portion 373 (of the adder 209) including the leading zero detection (LZD) logics 374 and 376. More particularly, the logics 374 and 376 may determine shift codes for normalization, e.g., by detecting the leading zeros in the results of the addition that are provided by the adders 352 and 354 through the multiplexers 368 and 370. The output signals from the logics 374 and 376 may be provided to logics 378 and 380, together with the output signals from the multiplexers 368 and 370. The logics 378 and 380 may perform cycle shifts left based on the outputs of logics 374 and 376 to provide normalization on the addition results. As shown in FIG. 3, the outputs of the logics 374 and 376 may be provided to an exponent adjustment logic 382 and mask generators 384 and 386. The mask generators 384 and 386 may generate masks based shift code signals from the logics 374 and 376 to enable normalization of the outputs of logics 378 and 380 by logics 388 and 390, respectively. In an embodiment, the logics 388 and 390 may logically combine their inputs (e.g., by utilizing a logic AND operation) such as discussed with reference to logics 346 and 348. The output signals from the logics 388 and 390 may be selected by multiplexing logic 392 (e.g., such as discussed with reference to logic 350 in an embodiment) to provide an output to the rounding portion 393 of the adder 209. In accordance with one embodiment, the logic 392 may provide guard and/or round bits to the rounding portion 393.

In an embodiment, in the addition portion 355 of the adder 209, logics 394 and 395 may compute sticky bits, e.g., by logically combining (for example through a logic OR operation) the shifted out bits provided by the logics 346 and 348 as will be further discussed with reference to FIG. 4. In turn, the logic 396 may combine the outputs of the logics 394 and 395 to provide two sticky bits for two single-precision operands, and a single sticky bit for double-precision and double-extended precision operands. The output signal from the logics 396 and 392 are provided to rounder logic 397 to perform rounding of the addition (or subtraction) of the mantissas. Additionally, a logic 398 may receive the exponent from the logic 382 and modify (or fix) the exponent for round up situations, e.g., by adding a one if round up occurs. Moreover, the logic 382 may adjust the exponent (e.g., received from logic 318) by the shift code for normalization (e.g., provided by the logics 374 and 376). In an embodiment, the logic 382 may subtract the shift codes received from logics 374 and 376 from the larger exponent provided by the logic 318. Hence, in one embodiment, the larger exponent provided by the logic 318 may be corrected for normalization (e.g., by logic 382) and round up situations (e.g., by logic 398).

In one embodiment (such as illustrated in FIG. 3), the mantissa path 304 may include two separate paths to process the most significant (MS) 32 bits and least significant (LS) 36 bits of operands 306 and 308. For example, a first MS 32-bit path (e.g., including logics 320, 324, 352, and/or 378) may operate on a first set of data (e.g., a pair of single precision floating point mantissas such as discussed with reference to the operand 602 of FIG. 6), while a second LS 36-bit path (e.g., including logics 322, 326, 354, and/or 380) may operate on a second set of data (which may be a different pair of single precision floating point mantissas). Hence, two pairs of single precision mantissas may be processed in these two paths independently. Also, a combination of the first and second paths may be used to operate on double precision or double extended precision operands (e.g., operands 630 and/or 650 of FIG. 6). As shown in FIG. 3, logics 350 and 392 may enable combination of signals between these two mantissa paths.

FIG. 4 illustrates a block diagram of further details of portions of the adder 209 of FIG. 3, according to an embodiment of the invention. As shown in FIG. 4, signals 402-410 that are generated by the logic 318 may be provided to multiplexers 412-416. The inputs to the multiplexers 412-416 may be selected by signals that are generated based on precision format of the opcode 312. The outputs of the multiplexers 412, 414, and 416 are provided to the logics 320, logics 336 and 324, and logics 338 and 326, respectively. In various embodiment, signal 402 may correspond to a shift code for alignment of MS 32-bits for the single precision case; signal 404 may correspond to a shift code for alignment for the double precision or double extended precision cases; signal 406 may correspond to a shift code for alignment of LS 36-bits for the single precision case; signal 408 may correspond to a carry-out signal from exponent difference of second pair of single precision data; and signal 410 may correspond to a carry-out signal from exponent difference of double precision or double extended precision data.

As shown in FIG. 4, in an embodiment, the logic 346 may include AND gates 424 and 426 to combine the outputs of the logic 340 and 336. Similarly, the logic 348 may include AND gates 428 and 430 to combine the outputs of the logic 338 and 342. Also, one of the inputs to the gates 426 and 430 may be inverted such as shown in FIG. 4. Furthermore, an OR gate 434 may combine the outputs of the gates 426 and 428 (e.g., by logically OR-ing the outputs of the gates 426 and 428). Additionally, the logic 350 may include multiplexers 436-440. As shown, the inputs of the multiplexers 436-440 may be selected by a signal 442 which is generated by a logic (e.g., based on precision format of the opcode 312 and on signals from 318 of FIG. 3) to indicate how an aligned mantissa is combined with signals from a storage unit 441 (which may be a hardware register in an embodiment) and logics 424, 434, and 428. Additionally, the multiplexers 436-440 may receive a signal from the storage unit 441 (e.g., including all zero's) to fill the first 32 bits of the output of the logic 350 with zeros for the case when exponent difference is more than 32 bits or fill the first 64 bits of the output of the logic 350 with zeros for the case when exponent difference is more than 64 bits. The logic 350 may provide the outputs of the multiplexers 436-440 in the 68 bit format 444 (which, in one embodiment, includes a most significant (MS) 32-bit portion 446, a middle 32-bit portion 448, and a least significant (LS) 32-bit portion 450) to the adders 352 and 354 such as illustrated in FIG. 4.

In various embodiments, portions 446, 448, and 450 may be provided in accordance with one or more of the following:
If the opcode 312 corresponds to a single precision format and the exponent difference (318) of the second pair of single precision operands (306 and 308) is less than 24, then portion 446 may be supplied by logic 424 through logic 436. A similar situation may be applied to the first pair of operands (306, 308) also; namely, portion 448 may be supplied by logic 428 through logic 438. Moreover, in an embodiment (such as discussed with reference to FIGS. 5 and 6), each of the operands (306 and 308) may include two single precision numbers (e.g., op1={x1,x0} and op2={y1,y0}, where “{ }” indicates concatenation). In such an embodiment, the first pair may correspond to x0 and y0, while the second pair may correspond to x1 and y1.
If the opcode 312 corresponds to double or double extended precision formats and exponent difference (318) is less than 32, then portion 446 may be supplied by logic 424 and portion 448 may be supplied by logic 434.
If the opcode 312 corresponds to double or double extended precision formats and exponent difference (318) is less than 64, and more than 32, then portion 446 may be supplied by storage unit 441 and portion 448 may be supplied by logic 424.

If opcode 312 corresponds to double or double extended precision formats and exponent difference (318) is more than 64, then portion 446 may be supplied from storage unit 441, portion 448 may be supplied by storage unit 441, and portion 450 may be supplied by logic 424.

FIG. 5 illustrates sample operand formats 500 for operands 306 and 308 of FIG. 3, in accordance with an embodiment of the invention. FIG. 6 illustrates formatted floating point adder operand formats 600 corresponding to the formats 500 of FIG. 5, after the operands of FIG. 5 are formatted by the logic 310 of FIG. 3. Width of each field of the operands shown in FIGS. 5 and 6 is illustrated in accordance with some embodiments of the invention.

Referring to FIG. 5, a single precision operand 502 (which may represent two single precision floating point numbers in an embodiment) may include sign fields 504 and 506, exponent fields 508 and 510, and mantissa fields 512 and 514. Also, a double precision operand 520 may include a sign filed 522, an exponent field 524, and a mantissa field 526. Furthermore, a double-extended precision operand 530 may include a sign filed 532, an exponent field 534, a J field 536 (which may indicate whether the mantissa is normalized), and a mantissa field 538. Generally, a J bit (536) may correspond to the integer part of a mantissa which may be hidden in single precision and double precision formats. Further, the J bit may be set to zero for denormals.

Referring to FIG. 6, a single precision operand 602 may include a sign fields 604 (which may correspond to the sign field 504), exponent fields 606 and 608 (which may correspond to fields 508 and 510 in an embodiment), a zero field 610 (which may correspond to the sign field 506), overflow fields 612 and 614 (e.g., to indicate an overflow condition in a path of the adder 209), J fields 616 and 618 (e.g., to indicate that the corresponding floating point number is normal), and mantissa fields 620 and 622 (which may correspond to fields 512 and 514 in an embodiment). Also, a double precision operand 630 may include a sign filed 632 (which may correspond to field 522 in an embodiment), an exponent field 634 (which may correspond to field 524 in an embodiment), an overflow field 636 (e.g., to indicate an overflow condition), a J field 638 (e.g., to indicate that the corresponding floating point number is normal), and a mantissa field 640 (which may correspond to the field 526 in an embodiment). Furthermore, a double-extended precision operand 650 may include a sign filed 652 (which may correspond to the field 532 in an embodiment), an exponent field 654 (which may correspond to the field 534 in an embodiment), an overflow field 656 (e.g., to indicate an overflow condition), a J field 658 (e.g., to indicate that the corresponding floating point number is normal), and a mantissa field 660 (which may correspond to the field 538 in an embodiment). As shown in FIG. 6, other fields of the operands 602, 630, and 650 may be unused (e.g., have all zeros). In an embodiment, the logic 310 may format the operands 502, 520, and 530 into the operands 602, 630, and 650, respectively.

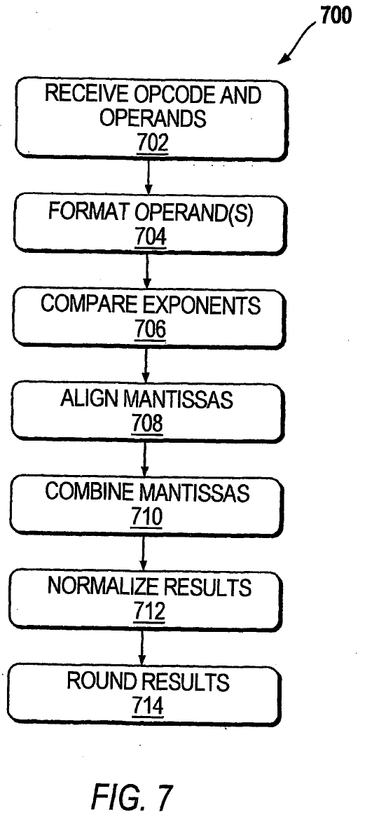

FIG. 7 illustrates a flow diagram of an embodiment of a method 700 to add and/or subtract floating point numbers, in accordance with an embodiment of the invention. In one embodiment, the floating point numbers being added and/or subtracted may be represented in varying floating point representation formats, for example, such as two single precision, double precision, and/or double-extended precision floating numbers such as those discussed with reference to FIGS. 5 and 6. In an embodiment, various components discussed with reference to FIGS. 1-6 and 8-9 may be utilized to perform one or more of the operations discussed with reference to FIG. 7. For example, the method 700 may be used to add and/or subtract floating point numbers stored (and/or read) from a storage unit such as the cache 108, cache 116, memory 114, and/or registers 222.

Referring to FIGS. 1-7, at an operation 702, the adder 209 may receive the opcode 312 and the operands 306-308. At an operation 704, the logic 310 may format the operands 306-308 such as discussed with reference to FIG. 3. The logic 318 may compare the exponents at an operation 706, such as discussed with reference to FIG. 3. The mantissas of the formatted operands may be aligned at an operation 708 by the alignment portion 305. At an operation 710, the aligned mantissas may be combined (e.g., added or subtracted) such as discussed with reference to the addition portion 355 of FIG. 3. The results of the addition portion 355 of the adder 209 may be normalized by accordance with an embodiment of the invention. Also, as illustrated in FIG. 3, the adder 209 may include an exponent path 302 and a mantissa path 304 to perform various operations corresponding to addition (or subtraction) of two operands 306 and 308.

As shown in FIG. 3, the adder 209 may include various portions including an alignment portion 305. The alignment portion 305 may include an operand formatting logic 310, e.g., to modify one or more of the operands 306 and 308 from a first format (such as those shown in FIG. 5) into a second format (such as those shown in FIG. 6). The exponent path 302 may receive an opcode 312 that corresponds to an arithmetic operation (such as an addition or subtraction). A logic 314 may determine (e.g., look up from a table or storage unit that includes predefined data) an exponent corresponding to opcode 312 for a conversion instruction. Generally, a conversion instruction may operate on a single operand (e.g., operand 308), while another operand (e.g., operand 306) is supplied with a zero value. Hence, in one embodiment, a predefined exponent from 314 may be used to calculate a resultant exponent and align data if it is needed, as will be discussed further with reference to FIG. 3. To this end, a multiplexer 316 may receive and select one of the exponents from the logic 314 and an exponent corresponding to one of the operands (e.g., operand 306). In an embodiment, the multiplexer 316 may select one of its inputs based on the opcode 312. An exponent difference logic 318 may receive and compare the selected exponent from the multiplexer 316 and an exponent corresponding to the operand 308. The logic 318 may generate one or more signals based on the result of the comparison (which may be one or more subtraction operations in an embodiment) and provide the generated signals (such as subtraction results and carry outs) to various components of the adder 209, for the normalization portion 373 at an operation 712. The results from the normalization portion 373 of the adder 209 may then be rounded at an operation 714, e.g., by the rounding portion 393 such as discussed with reference to FIG. 3.

FIG. 8 illustrates a block diagram of a computing system 800 in accordance with an embodiment of the invention. The computing system 800 may include one or more central processing unit(s) (CPUs) 802 or processors that communicate via an interconnection network (or bus) 804. The processors 802 may include a general purpose processor, a network processor (that processes data communicated over a computer network 803), or other types of a processor (including a reduced instruction set computer (RISC) processor or a complex instruction set computer (CISC)). Moreover, the processors 802 may have a single or multiple core design. The processors 802 with a multiple core design may integrate different types of processor cores on the same integrated circuit (IC) die. Also, the processors 802 with a multiple core design may be implemented as symmetrical or asymmetrical multiprocessors. In an embodiment, one or more of the processors 802 may be the same or similar to the processors 102 of FIG. 1. For example, one or more of the processors 802 may include one or more of the cores 106 (e.g., including the adder 209) and/or cache 108. Also, the operations discussed with reference to FIGS. 1-7 may be performed by one or more components of the system 800.

A chipset 806 may also communicate with the interconnection network 804. The chipset 806 may include a memory control hub (MCH) 808. The MCH 808 may include a memory controller 810 that communicates with the memory 114. The memory 114 may store data, including sequences of instructions that are executed by the CPU 802, or any other device included in the computing system 800. In one embodiment of the invention, the memory 114 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 804, such as multiple CPUs and/or multiple system memories.

The MCH 808 may also include a graphics interface 814 that communicates with a graphics accelerator 816. In one embodiment of the invention, the graphics interface 814 may communicate with the graphics accelerator 816 via an accelerated graphics port (AGP). In an embodiment of the invention, a display (such as a flat panel display) may communicate with the graphics interface 814 through, for example, a signal converter that translates a digital representation of an image stored in a storage device such as video memory or system memory into display signals that are interpreted and displayed by the display. The display signals produced by the display device may pass through various control devices before being interpreted by and subsequently displayed on the display.

A hub interface 818 may allow the MCH 808 and an input/output control hub (ICH) 820 to communicate. The ICH 820 may provide an interface to I/O devices that communicate with the computing system 800. The ICH 820 may communicate with a bus 822 through a peripheral bridge (or controller) 824, such as a peripheral component interconnect (PCI) bridge, a universal serial bus (USB) controller, or other types of peripheral bridges or controllers. The bridge 824 may provide a data path between the CPU 802 and peripheral devices. Other types of topologies may be utilized. Also, multiple buses may communicate with the ICH 820, e.g., through multiple bridges or controllers. Moreover, other peripherals in communication with the ICH 820 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 822 may communicate with an audio device 826, one or more disk drive(s) 828, and a network interface device 830 (which is in communication with the computer network 803). Other devices may communicate via the bus 822. Also, various components (such as the network interface device 830) may communicate with the MCH 808 in some embodiments of the invention. In addition, the processor 802 and the MCH 808 may be combined to form a single chip. Furthermore, the graphics accelerator 816 may be included within the MCH 808 in other embodiments of the invention.

Furthermore, the computing system 800 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 828), a floppy disk, a compact disk ROM (CD-ROM), a digital versatile disk (DVD), flash memory, a magneto-optical disk, or other types of nonvolatile machine-readable media that are capable of storing electronic data (e.g., including instructions).

FIG. 9 illustrates a computing system 900 that is arranged in a point-to-point (PtP) configuration, according to an embodiment of the invention. In particular, FIG. 9 shows a system where processors, memory, and input/output devices are interconnected by a number of point-to-point interfaces. The operations discussed with reference to FIGS. 1-8 may be performed by one or more components of the system 900.

As illustrated in FIG. 9, the system 900 may include several processors, of which only two, processors 902 and 904′ are shown for clarity. The processors 902 and 904 may each include a local memory controller hub (MCH) 906 and 908 to enable communication with memories 910 and 912. The memories 910 and/or 912 may store various data such as those discussed with reference to the memory 114 of FIG. 8.

In an embodiment, the processors 902 and 904 may be one of the processors 802 discussed with reference to FIG. 8. The processors 902 and 904 may exchange data via a point-to-point (PtP) interface 914 using PtP interface circuits 916 and 918, respectively. Also, the processors 902 and 904 may each exchange data with a chipset 920 via individual PtP interfaces 922 and 924 using point-to-point interface circuits 926, 928, 930, and 932. The chipset 920 may further exchange data with a high-performance graphics circuit 934 via a high-performance graphics interface 936, e.g., using a PtP interface circuit 937.

At least one embodiment of the invention may be provided within the processors 902 and 904. For example, one or more of the cores 106 (e.g., including the adder 209) and/or cache 108 of FIG. 1 may be located within the processors 902 and 904. Other embodiments of the invention, however, may exist in other circuits, logic units, or devices within the system 900 of FIG. 9. Furthermore, other embodiments of the invention may be distributed throughout several circuits, logic units, or devices illustrated in FIG. 9.

The chipset 920 may communicate with a bus 940 using a PtP interface circuit 941. The bus 940 may have one or more devices that communicate with it, such as a bus bridge 942 and I/O devices 943. Via a bus 944, the bus bridge 943 may communicate with other devices such as a keyboard/mouse 945, communication devices 946 (such as modems, network interface devices, or other communication devices that may communicate with the computer network 803), audio I/O device, and/or a data storage device 948. The data storage device 948 may store code 949 that may be executed by the processors 902 and/or 904.

In various embodiments of the invention, the operations discussed herein, e.g., with reference to FIGS. 1-9, may be implemented as hardware (e.g., circuitry), software, firmware, microcode, or combinations thereof, which may be provided as a computer program product, e.g., including a machine-readable or computer-readable medium having stored thereon instructions (or software procedures) used to program a computer to perform a process discussed herein. Also, the term “logic” may include, by way of example, software, hardware, or combinations of software and hardware. The machine-readable medium may include a storage device such as those discussed with respect to FIGS. 1-9. Additionally, such computer-readable media may be downloaded as a computer program product, wherein the program may be transferred from a remote computer (e.g., a server) to a requesting computer (e.g., a client) by way of data signals embodied in a carrier wave or other propagation medium via a communication link (e.g., a bus, a modem, or a network connection). Accordingly, herein, a carrier wave shall be regarded as comprising a machine-readable medium.

Reference in the specification to “one embodiment” or “an embodiment” means that a particular feature, structure, or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

1-20. (canceled)

21. A processor comprising:
a first logic to convert a first operand from a first format into a second format; and
a second logic to combine a portion of the converted first operand with a portion of a second operand that is in the second format.

22. The processor of claim 21, further comprising a third logic to compare a first exponent corresponding to the first operand with a second exponent of the second operand.

23. The processor of claim 22, further comprising a fourth logic to modify a larger one of the first exponent or second exponent in accordance with the comparison.

24. The processor of claim 22, further comprising a fourth logic to align the portion of the converted first operand and the portion of the second operand in accordance with the comparison.

25. The processor of claim 21, wherein the second logic combines a plurality of single precision operands in a same path as a double precision exponent or a double-extended precision path.

26. The processor of claim 21, further comprising a third logic to convert the second operand from a third format into the second format.

27. The processor of claim 21, wherein the portion of the converted first operand or the portion of the second operand comprises a mantissa.

28. The processor of claim 21, wherein the second logic combines the portion of the converted first operand and the portion of the second operand by an addition operation or a subtraction operation.

29. The processor of claim 21, further comprising a third logic to normalize results of the combination by the second logic.

30. The processor of claim 21, further comprising a third logic to round results of the combination by the second logic.

31. The processor of claim 21, further comprising a third logic to analyze a portion of the converted first operand and the second operand to determine whether one of the first or second operands corresponds to a denormal operand.

32. The processor of claim 21, further comprising one or more processor cores, wherein at least some of the one or more processor cores comprise one or more of the first logic or the second logic.

33. The apparatus of claim 32, wherein at least one of the one or more processor cores, the first logic, and the second logic are on a same die.

34. A method comprising:
modifying a plurality of operands into a same format; and
combining a plurality of mantissas corresponding to the modified plurality of operands.

35. The method of claim 34, further comprising comparing portions of the modified plurality of operands.

36. The method of claim 34, further comprising aligning portions of the plurality of mantissas.

37. The method of claim 34, wherein combining the plurality of mantissas comprises adding the plurality of mantissas.

38. The method of claim 34, further comprising normalizing results of the combination of the plurality of mantissas.

39. The method of claim 34, further comprising rounding results of the combination of the plurality of mantissas.

40. A system comprising:
a memory to store data;
a first logic to fetch an opcode, a first operand, and a second operand from the memory;
a second logic to modify the first operand and the second operand into a same format; and
a third logic to align one of the first or second operands in accordance with a comparison of a first exponent corresponding to the first operand and a second exponent corresponding to the second operand.

41. The system of claim 40, further comprising a fourth logic to combine a portion of the first operand and a portion of the second operand.

42. The system of claim 41, further comprising a fifth logic to normalize an output of the fourth logic.

43. The system of claim 41, further comprising a fifth logic to round an output of the fourth logic.

44. The system of claim 41, wherein the fourth logic combines the portion of the first operand and the portion of the second operand through an addition operation or a subtraction operation.

45. The system of claim 40, further comprising a fourth logic to rotate an output of the second logic or the third logic.

46. The system of claim 40, further comprising a fourth logic to analyze a portion of the first operand and the second operand to determine whether one of the first or second operands corresponds to a denormal operand.

47. The system of claim 40, wherein the memory comprises one or more of a level 1 cache, a mid-level cache, or a last level cache.

48. The system of claim 40, further comprising a plurality of processor cores to access the data stored in the memory.

49. The system of claim 48, wherein at least one of the plurality of processor cores and the first logic are on a same die.

50. The system of claim 40, further comprising an audio device.
